(19) United States
(12) Patent Application Publication
(10) Pub. No.: US 2020/0073837 A1
(43) Pub. Date: Mar. 5, 2020

(54) BRIDGE DEVICE, METHOD FOR CONTROLLING BRIDGE DEVICE, AND INFORMATION PROCESSING APPARATUS INCLUDING BRIDGE DEVICE

(71) Applicant: CANON KABUSHIKI KAISHA, Tokyo (JP)

(72) Inventor: Yasushi Shinto, Inagi-shi (JP)

(21) Appl. No.: 16/542,741

(22) Filed: Aug. 16, 2019

(30) Foreign Application Priority Data
Aug. 31, 2018 (JP) 2018-163192

(51) Int. Cl. G06F 13/362; G06F 13/40; G06F 1/3287; G06F 1/3206

(52) U.S. Cl. CPC G06F 13/362; G06F 1/3206; G06F 1/3287; G06F 13/4027

(57) ABSTRACT

A bridge device includes a first communication unit configured to perform data transfer with a first device based on a command received from the first device, a second communication unit configured to perform data transfer with a second device based on the command received from the first device, a storage unit configured to store data input via the first communication unit or the second communication unit, and a control unit configured to stop the data transfer of the second communication unit with the second device based on a state of the storage unit.

### BACKGROUND OF THE INVENTION

### Field of the Invention

The present disclosure relates to a bridge device, a method for controlling a bridge device, and an information processing apparatus including the bridge device.

### Description of the Related Art

In an information processing apparatus, a memory for storing an operation log of software executed by a central processing unit (CPU) is connected to a main bus of a controller via a memory controller.

The memory controller and the memory are connected to each other in compliance with a serial interface standard such as a Serial Peripheral Interface (SPI) standard. The memory controller operates as a master device, and the memory as a slave device to be controlled by the master device. Communication complaint with the SPI standard is performed by using a clock signal line for transferring a clock signal and data signal lines for transferring data. The master device supplies a clock signal to the clock signal line and outputs data to the data signal lines. The slave device receives the data in synchronization with the clock signal input from the master device via the clock signal line.

Japanese Patent Application Laid-Open No. 2006-304011 discusses a configuration in which a master device is connected to a plurality of slave devices having different data transfer speeds, and data output from the master device is stored in a buffer and the slave devices read the data from the buffer. According to Japanese Patent Application Laid-Open No. 2006-304011, the buffering of data enables data transfer at the data transfer speeds of the slave devices used in the data transfer even if the master device and the slave devices have different data transfer speeds.

A master device and a slave device can be connected to each other by using a bridge device using a buffer. In such a configuration, data transfer between the bridge device and the slave device is not able to be properly completed if the buffer is emptied or enters a memory-full state during the data transfer.

For example, suppose that the data transfer speed between the master device and the bridge device is lower than that between the bridge device and the slave device. If the master device makes a read access to the slave device via the bridge device, the buffer can run short of free space before the master device completes reading data written to the buffer. If data read from the slave device is stored into the buffer here, the data that the master device has not completed reading can be lost. Now, suppose that, in such a configuration, the master device makes a write access to the slave device via the bridge device. If the slave device completes reading data written to the buffer before the master device writes new data to the buffer, the buffer becomes empty. If the slave device continues reading data from the buffer here, the slave device reads data different from that to be written to the slave device from the buffer. As described above, proper data transfer is difficult if the buffer in the bridge device is emptied or runs short of free space during data transfer between the bridge device and the slave device.

### SUMMARY OF THE INVENTION

According to an aspect of the present disclosure, a bridge device includes a first communication unit configured to perform data transfer with a first device based on a command received from the first device, a second communication unit configured to perform data transfer with a second device based on the command received from the first device, a storage unit configured to store data input via the first communication unit or the second communication unit, and a control unit configured to stop the data transfer of the second communication unit with the second device based on a state of the storage unit.

Further features of the present disclosure will become apparent from the following description of exemplary embodiments with reference to the attached drawings.

### BRIEF DESCRIPTION OF THE DRAWINGS

FIG. 1 is a diagram illustrating an outline of an information processing apparatus according to an exemplary embodiment.

FIG. 2 is a block diagram of a controller unit of the information processing apparatus according to the present exemplary embodiment.

FIG. 3 is a diagram illustrating details of a Quad Serial Peripheral Interface (QSPI) master device, a QSPI bridge device, and QSPI slave devices according to the present exemplary embodiment.

FIG. 4 is a timing chart of a write access compliant with a QSPI standard according to the present exemplary embodiment.

FIG. 5 is a timing chart of a read access compliant with the QSPI standard according to the present exemplary embodiment.

FIG. 6 is a diagram illustrating an example of a memory map of the QSPI slave devices according to the present exemplary embodiment.

FIGS. 7A and 7B are timing charts of the QSPI bridge device according to the present exemplary embodiment during a write access.

FIGS. 8A and 8B are timing charts of the QSPI bridge device according to the present exemplary embodiment during a read access.

FIGS. 9A and 9B are flowcharts illustrating processing performed by the QSPI bridge device according to the present exemplary embodiment during a write access.

FIGS. 10A and 10B are flowcharts illustrating processing performed by the QSPI bridge device according to the present exemplary embodiment during a read access.

### DESCRIPTION OF THE EMBODIMENTS

Exemplary embodiments of the present disclosure will be described below with reference to the drawings. Configurations described in the following first exemplary embodiment are merely examples. The present disclosure is not limited to the illustrated configurations.

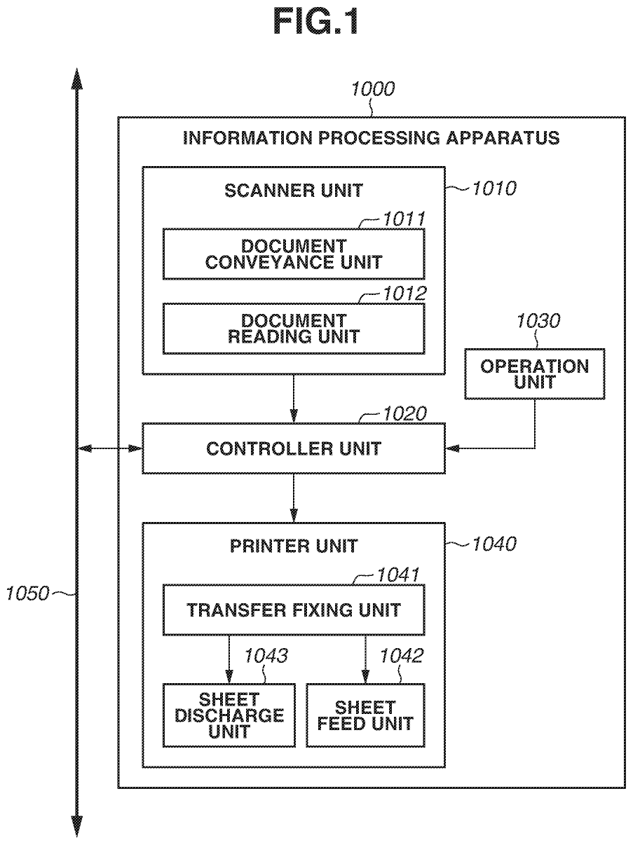

FIG. 1 is a block diagram illustrating an example of a configuration of a digital multifunction peripheral operating as an information processing apparatus 1000 according to the present exemplary embodiment. A scanner unit 1010 optically reads a document and converts the read document into image data. The scanner unit 1010 includes a document reading unit 1012 that includes a laser light source and lens for optically reading the document, and a document conveyance unit 1011 that includes a belt for conveying the document. A printer unit 1040 conveys a recording medium (sheet) and prints image data on the sheet as a visible image. The printer unit 1040 includes a sheet feed unit 1042 that feeds sheets, a transfer fixing unit 1041 that transfers an image to a sheet and fixes the image, and a sheet discharge unit 1043 that sorts printed sheets, staples the sorted sheets, and conveys the stapled sheets to outside the information processing apparatus 1000.

A controller unit 1020 is electrically connected to the scanner unit 1010 and the printer unit 1040. The controller unit 1020 is also connected to a network 1050 such as a local area network (LAN), Integrated Services Digital Network (ISDN), the Internet, and an intranet. If the user uses a copy function, the controller unit 1020 controls the scanner unit 1010 to obtain image data on a document, and controls the printer unit 1040 to print an image on a sheet and output the printed sheet. If the user uses a scan function, the controller unit 1020 controls the scanner unit 1010 to obtain image data on a document and convert the image data into code data, and transmits the code data to a host personal computer (PC) (not illustrated) via the network 1050. If the user uses a print function, the controller unit 1020 converts print data (code data) received from the host PC via the network 1050 into image data, and controls the printer unit 1040 to print an image on a sheet and output the printed sheet. The information processing apparatus 1000 also has a facsimile (FAX) reception function of receiving data from ISDN and printing the data, and a FAX transmission function of transmitting scanned data to ISDN. Processing execution instructions for such functions are called jobs. The information processing apparatus 1000 performs predetermined processing based on jobs corresponding to the functions. An operation unit 1030 is a user interface for the user to make input operations. For example, the operation unit 1030 includes a touch panel and various buttons.

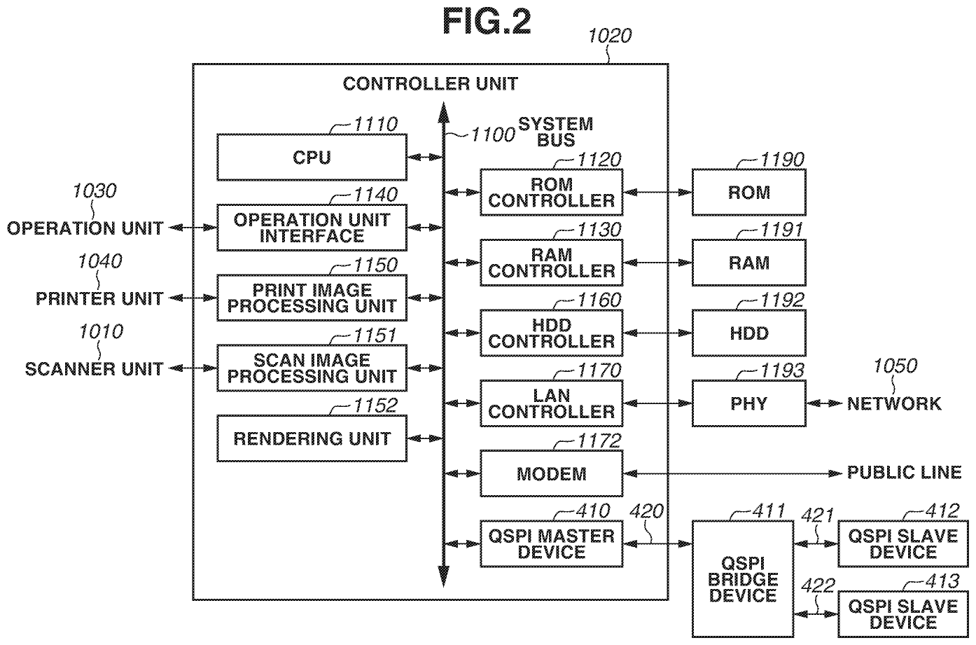

FIG. 2 is a block diagram illustrating an internal configuration of the controller unit 1020 according to the present exemplary embodiment. The components of the controller unit 1020 are described below.

A central processing unit (CPU) 1110 is a processor that controls the entire system. The CPU 1110 controls job processing such as print processing and scan processing in a centralized manner based on an operating system (OS) and control programs loaded into a random access memory (RAM) 1191.

A read-only memory (ROM) controller 1120 is a control module for accessing a ROM 1190 in which a system boot program is stored. When the information processing apparatus 1000 is powered on, the CPU 1110 accesses the ROM 1190 via the ROM controller 1120 and boots up.

A RAM controller 1130 is a control module for accessing the RAM 1191 that stores system control programs and image data. The RAM controller 1130 includes a register for setting and controlling the RAM 1191. The register is accessible by the CPU 1110. An operation unit interface 1140 controls acceptance of operation instructions made by the user operating the operation unit 1030 and display of operation results.

A scan image processing unit 1151 performs scanner-specific image processing on image data obtained by the scanner unit 1010. Examples of the scanner-specific image processing include shading correction processing, modulation transfer function (MTF) correction processing, gamma correction processing, and filter processing. The scan image processing unit 1151 has a function of detecting a synchronization signal having abnormal cycles due to the effect of electrostatic noise, masking the detected synchronization signal having abnormal cycles, and counting the number of synchronization signals having abnormal cycles.

A print image processing unit 1150 performs print-specific image processing intended for image data to be used by the printer unit 1040. Examples of the print-specific image processing include color space conversion processing, halftone processing, and gamma correction processing. The print-specific image processing is applied to the image data, and the print image processing unit 1150 outputs the processed image data to the printer unit 1040.

A hard disk drive (HDD) 1192 stores system software, application programs, image data, page information and job information corresponding to each piece of image data. The HDD 1192 is connected to a system bus 1100 via an HDD controller 1160, and writes and reads data based on instructions from the CPU 1110.

A LAN controller 1170 is connected to the network 1050 via a physical layer chip (PHY) 1193. The LAN controller 1170 inputs and outputs information such as image data from/to an external host computer.

A modem 1172 is connected to a not-illustrated public line, and performs data communication with an external FAX device to execute FAX transmission and FAX reception jobs. A rendering unit 1152 converts image data (page description language (PDL) data) received from the network 1050 via the LAN controller 1170 into bitmap data that the printer unit 1040 can handle.

A Quad Serial Peripheral Interface (QSPI) master device 410 is a control module for accessing QSPI slave devices 412 and 413 via a QSPI bridge device 411. Examples of the QSPI slave devices 412 and 413 include a memory device having a QSPI interface (I/F). The QSPI master device 410 and the QSPI bridge device 411 are connected to each other via a first QSPI I/F 420.

The QSPI bridge device 411 transfers data transferred from the QSPI master device 410 via the first QSPI I/F 420 to the QSPI slave devices 412 and 413. The QSPI bridge device 411 is connected to the QSPI slave device 412 via a second QSPI I/F 421. The QSPI bridge device 411 is connected to the QSPI slave device 413 via a third QSPI I/F 422.

The QSPI slave devices 412 and 413 are memory devices such as a ferroelectric random access memory (FRAM (registered trademark)) and a static random access memory (SRAM) having a QSPI I/F. In the present exemplary embodiment, the QSPI slave devices 412 and 413 record logs of boot processing performed by the CPU 1110 and of program execution. In the present exemplary embodiment, the QSPI slave devices 412 and 413 are described by using memory devices as an example. However, the QSPI slave devices 412 and 413 are not limited thereto.

In the present exemplary embodiment, the controller unit 1020 is mounted on a first printed circuit board. The QSPI bridge device 411 and the QSPI slave devices 412 and 413 are mounted on a second printed circuit board.

The present exemplary embodiment is configured so that a plurality of QSPI slave devices 412 and 413 can be connected to one QSPI master device 410 by using the QSPI bridge device 411 as illustrated in FIG. 2. The use of the QSPI bridge device 411 can increase the number of QSPI slave devices connected to the QSPI master device 410 without changing the configuration of the QSPI master device 410. If the QSPI slave devices are memories such as an FRAM, the number of QSPI slave devices can be increased to increase the memory capacity in a pseudo manner by using the QSPI bridge device 411.

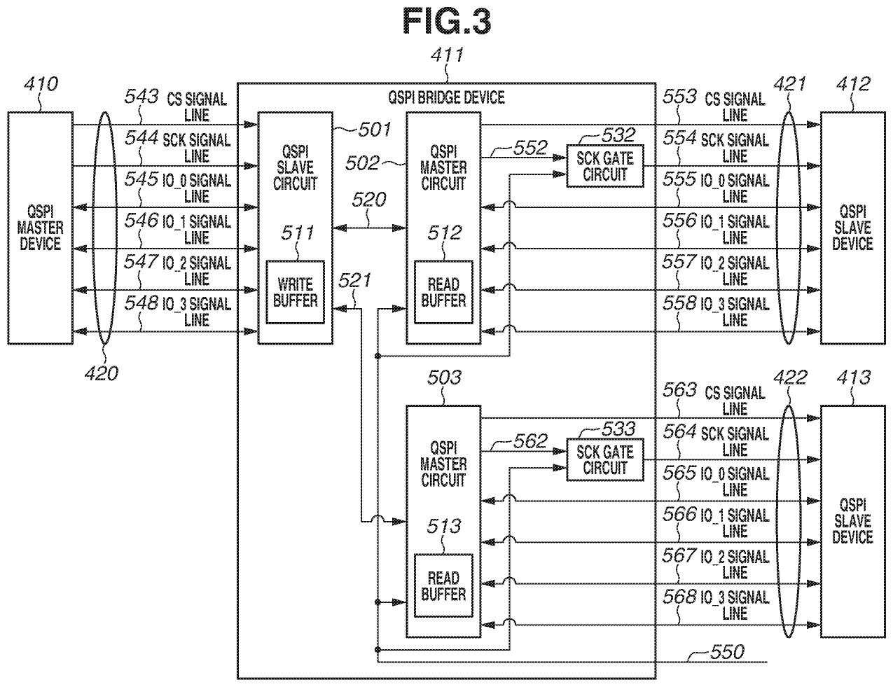

Details of the QSPI master device 410, the QSPI bridge device 411, and the QSPI slave devices 412 and 413 according to the present exemplary embodiment will be described with reference to FIG. 3.

The QSPI bridge device 411 includes a QSPI slave circuit 501, QSPI master circuits 502 and 503, and synchronous clock (SCK) gate circuits 532 and 533.

The QSPI master device 410 and the QSPI slave circuit 501 perform communication compliant with the QSPI standard by using the following six signal lines.

A chip select (CS) signal line 543 is a signal line that transmits a CS signal by which the QSPI master device 410 notifies the QSPI slave circuit 501 of a start of access of a device to be accessed. An SCK signal line 544 is a signal line that transmits a clock signal for synchronizing data transfer performed by using IO_0 to IO_3 signal lines 545 to 548. In the communication compliant with the QSPI standard, the clock signal is output only during data transfer. After the completion of data transfer, the QSPI master device 410 negates the CS signal and stops outputting the clock signal.

The IO_0 to IO_3 signal lines 545 to 548 are signal lines for the QSPI master device 410 and the QSPI slave circuit 501 to perform data transfer therebetween.

A write buffer 511 is a buffer for temporarily storing data to be written to the QSPI slave device 412 or 413 when the QSPI master device 410 makes a write access. In the present exemplary embodiment, the QSPI slave circuit 501 includes a write buffer 511 having a capacity for eight clocks. The capacity of the write buffer 511 is not limited to the foregoing.

The QSPI slave circuit 501 and the QSPI master circuit 502 are connected to each other via a signal line 520. The signal line 520 includes signal lines for transferring an opcode obtained by analyzing a signal transferred from the QSPI master device 410, signal lines for transferring an address, and signal lines for transferring data stored in the write buffer 511. The signal line 520 further includes a signal line for transferring a data communication enable signal for controlling operation of the QSPI master circuit 502. The signal lines included in the signal line 520 are connected to buffers in the QSPI slave circuit 501. The QSPI slave circuit 501 writes data to the buffers in synchronization with the clock signal input from the QSPI master device 410. The QSPI master circuit 502 reads the data stored in the QSPI slave circuit 501 and passes the read data to the QSPI slave device 412 in synchronization with a clock signal input via an external clock signal line 550. In FIG. 3 and the following description, the signal line 520 is called so for the sake of simplification, whereas the signal line 520 includes a plurality of signal lines as described above.

The QSPI slave circuit 501 and the QSPI master circuit 503 are connected to each other via a signal line 521. Details of the signal line 521 are similar to those of the signal line 520. A description thereof will thus be omitted.

The external clock signal line 550 is a signal line for supplying a clock signal having a frequency different from that of the SCK signal line 544 to the QSPI master circuits 502 and 503. In the present exemplary embodiment, the clock signal supplied to the QSPI master circuits 502 and 503 via the external clock signal line 550 has a frequency higher than that of the clock signal supplied from the QSPI master device 410 to the QSPI slave circuit 501. An oscillator that supplies the clock signal to the external clock signal line 550 is different from the one that supplies the clock signal to the QSPI master device 410.

The QSPI master circuit 502 is connected to the QSPI slave device 412 via the SCK gate circuit 532. The QSPI master circuit 502 and the QSPI slave device 412 transfer data in compliance with the QSPI standard. A CS signal line 553, an SCK signal line 554, and IO_0 to IO_3 signal lines 555 to 558 are similar to the signal lines between the QSPI master device 410 and the QSPI slave circuit 501. A description thereof will thus be omitted.

The SCK gate circuit 532 is a circuit that performs control to gate a clock signal output from the QSPI master circuit 502 so that the clock signal is not input to the QSPI slave device 412. For example, if the write buffer 511 becomes empty during a write access from the QSPI master device 410, the SCK gate circuit 532 temporarily stops supplying the clock signal to the QSPI slave device 412. The SCK gate circuit 532 also stops supplying the clock signal to the QSPI slave device 412 if a read buffer 512 becomes full during a read access from the QSPI master device 410.

The read buffer 512 is a buffer for storing read data transferred from the QSPI slave device 412. In the present exemplary embodiment, the read buffer 512 is a buffer having a capacity for eight clocks. The capacity of the read buffer 512 is not limited thereto.

The QSPI master circuit 503 is connected to the QSPI slave device 413 via the SCK gate circuit 533. The QSPI master circuit 503 and the QSPI slave device 413 transfer data in compliance with the QSPI standard. The configuration between the QSPI master circuit 503 and the QSPI slave device 413 is similar to that between the QSPI master circuit 502 and the QSPI slave device 412. A description thereof will thus be omitted.

According to the QSPI standard, a start and end of data transfer can be controlled only by a master-side device. For example, if the QSPI master device 410 writes data and the write buffer 511 becomes full, the QSPI slave circuit 501 is unable to stop the data transfer from the QSPI master device 410. In the present exemplary embodiment, the clock signal (external clock signal) supplied to the QSPI master circuit 502 is therefore given a frequency higher than that of the clock signal supplied from the QSPI master device 410 to the QSPI slave circuit 501. This makes the reading speed of data from the write buffer 511 higher than the writing speed of data to the write buffer 511. The write buffer 511 can thereby be prevented from becoming full. In the present exemplary embodiment, the external clock signal has a frequency twice that of the clock signal supplied to the QSPI slave circuit 501. The frequency of the external clock signal need only to be slightly higher than that of the clock signal supplied to the QSPI slave circuit 501.

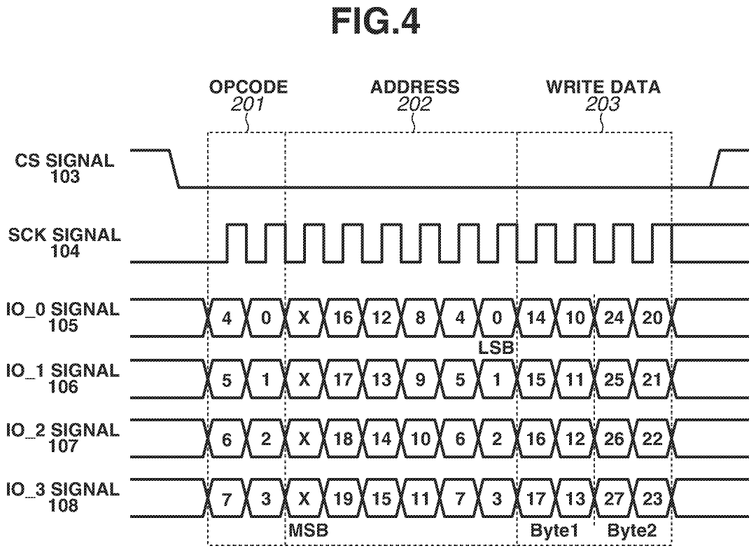

FIG. 4 is a timing chart when the QSPI master device 410, the QSPI master circuit 502, or the QSPI master circuit 503 makes a write access to the corresponding slave circuit or device in compliance with the QSPI standard. The signals compliant with the QSPI standard have three phases including an opcode 201, an address 202, and write data 203. The numerals written in the blocks representing pieces of data transferred via the data signal lines labeled with IO_0 to IO_3 signals 105 to 108 indicate the order of bits in which the slave circuit or device analyzes the data. In the write data 203, the first digit of the number in each block indicates a byte number, and the last digit the order of analysis.

The opcode 201 is a signal for indicating what processing is to be performed on a QSPI slave. The opcode 201 is transmitted by eight bits in two clocks after the assertion of a CS signal 103. The zeroth bit of the IO_0 signal 105 is the least significant bit of the signal transmitted in the phase of the opcode 201. The seventh bit of the IO_3 signal 108 is the most significant bit.

The address 202 is a signal for designating an address to start a data write at. The address 202 is designated by 24 bits in six clocks, and transmitted after the opcode 201. Both the QSPI slave devices 412 and 413 used in the present exemplary embodiment are FRAMs having a capacity of 512 Kbytes. In other words, the QSPI bridge device 411 is connected to 1 Mbyte FRAMs. In the present exemplary embodiment, an address in each QSPI slave device is thus designated by using the zeroth to nineteenth, 20 bits of the 24-bit signal. The QSPI bridge device 411 disables the 20th to 23rd bits of the signal. In the present exemplary embodiment, the disabled pieces of data are marked with X.

The write data 203 is the data signal to be stored into the QSPI slave device 412 or 413. In the phase of the write data 203, the data to be written can be continuously output. If write data is continuously output, the data is written while incrementing the address to be accessed by one at a time, starting at the address designated by the address 202.

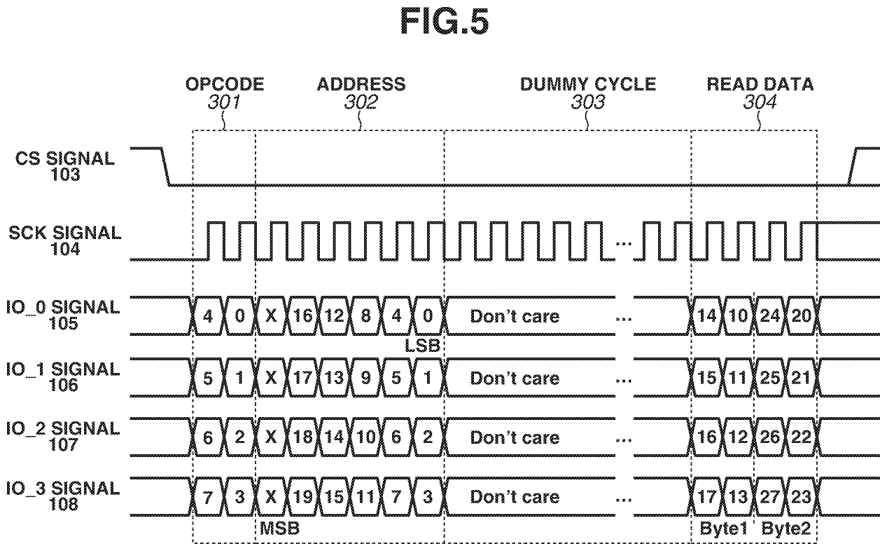

FIG. 5 is a timing chart when the QSPI master device 410, the QSPI master circuit 502, or the QSPI master circuit 503 makes a read access to the corresponding slave circuit or device in compliance with the QSPI standard. The first digit of the number in each block of read data 304 in FIG. 5 indicates the byte number, and the last digit the order of analysis when the QSPI master device 410 receives the data.

A read command includes the phases of an opcode 301, an address 302, a dummy cycle 303, and read data 304. The opcode 301 and the address 302 are similar to those of a write command. A description thereof will thus be omitted. The dummy cycle 303 is a phase indicating a wait time needed for the slave circuit or device to read data. The number of dummy cycles determined for the connected slave device in advance is set in the master-side device. When outputting a read command, the master-side device outputs a predetermined number of cycles of the clock signal as the dummy cycle 303. The master-side device disables data received during the dummy cycle 303, if any. In the read data 304, data stored at the address designated by the address 302 is obtained. In the read data 304, data can be continuously obtained. The data is obtained from the QSPI slave device 412 or 413 while incrementing the address by one at a time, starting at the address designated by the address 302.

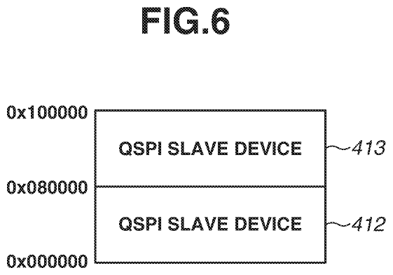

FIG. 6 is a diagram illustrating a relationship between addresses that the QSPI master device 410 designates in an address phase and the QSPI slave devices 412 and 413 corresponding to the addresses in the present exemplary embodiment. The addresses are expressed in hexadecimal notation. Addresses 0x000000 to 0x07FFFF correspond to the QSPI slave device 412. Addresses 0x080000 to 0x0FFFFF correspond to the QSPI slave device 413. In other words, if the 20th bit in binary notation is 0, the access is made to the QSPI slave device 412. If the 20th bit in binary notation is 1, the access is made to the QSPI slave device 413. In the present exemplary embodiment, consecutive addresses are thus assigned to a plurality of QSPI slave devices. The plurality of QSPI slave devices can be thereby handled as if to be a single QSPI slave device. If the QSPI master device 410 makes an access to a plurality of QSPI slave devices, the access can be switched to the next QSPI slave device by simply incrementing the address to be accessed.

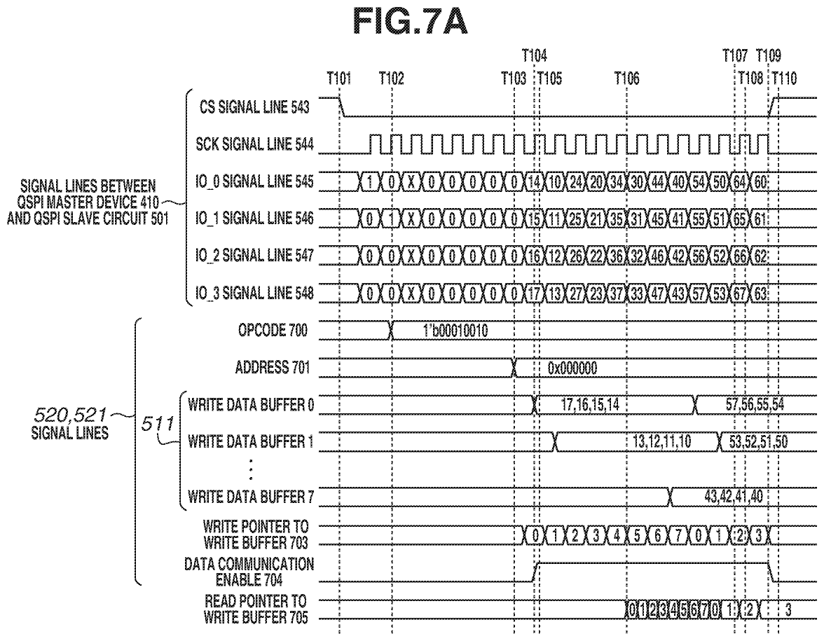

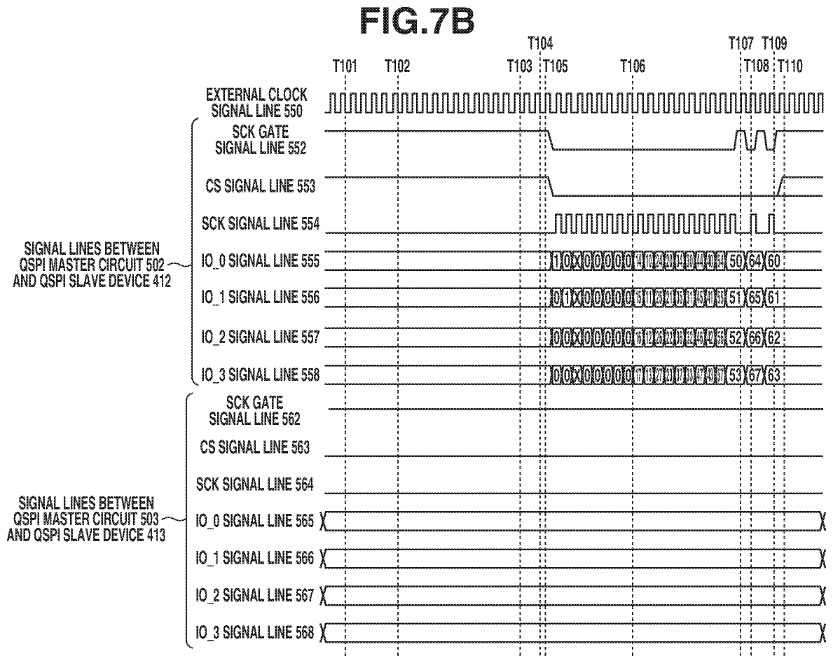

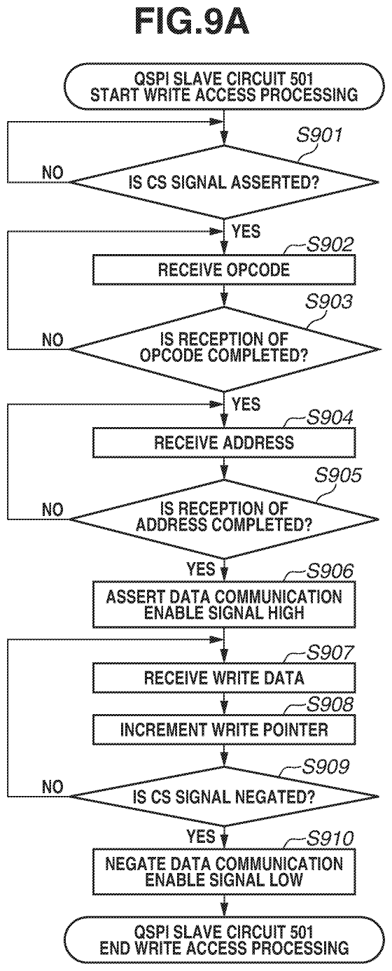

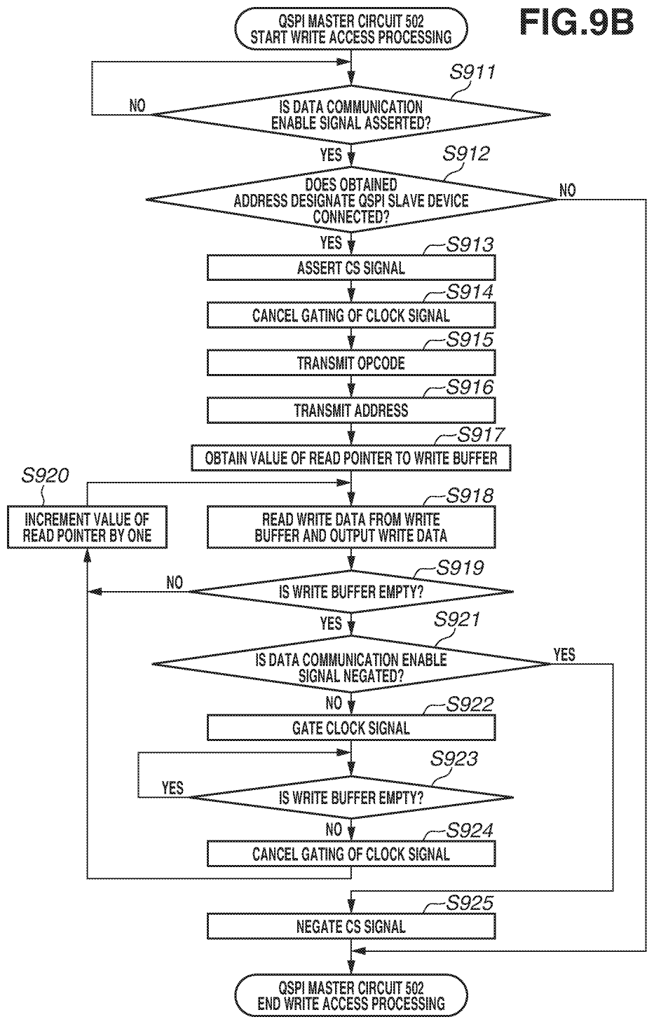

Next, operation executed when the QSPI bridge device 411 accepts a write access from the QSPI master device 410 will be described with reference to FIGS. 7A, 7B, 9A, and 9B. FIGS. 7A and 7B are timing charts when the QSPI bridge device 411 accepts a write access. FIGS. 9A and 9B are flowcharts illustrating processing performed by the QSPI slave circuit 501 and processing performed by the QSPI master circuit 502 when the QSPI bridge device 411 accepts a write access. Here, a write access to the QSPI slave device 412 will be described as an example.

A CS signal line 543, an SCK signal line 544, and IO_0 to IO_3 signal lines 545 to 548 in FIG. 7A indicate the states of the respective signal lines between the QSPI master device 410 and the QSPI slave circuit 501. An opcode 700, an address 701, write data buffers 0 to 7 511, a write pointer 703, and data communication enable 704 indicate the states of the signal lines 520 and 521 between the QSPI slave circuit 501 and the QSPI master circuits 502 and 503. A read pointer 705 to a write buffer is a read pointer indicating the access destination in the write buffer 511 and managed by the QSPI master circuit 502. An external clock signal line 550 indicates the external clock signal input to the QSPI master circuits 502 and 503 and the SCK gate circuits 532 and 533. An SCK gate signal line 552 indicates the state of the signal line connecting the QSPI master circuit 502 and the SCK gate circuit 532. A CS signal line 553, an SCK signal line 554, and IO_0 to 103 signal lines 555 to 558 indicate the states of the signal lines between the QSPI master circuit 502 and the QSPI slave device 412. An SCK gate signal line 562 indicates the state of the signal line connecting the QSPI master circuit 503 and the SCK gate circuit 533. A CS signal line 563, an SCK signal line 564, and IO_0 to IO_3 signal lines 565 to 568 indicate the states of the signal lines between the QSPI master circuit 503 and the QSPI slave device 413.

FIG. 9A is a flowchart illustrating the processing performed by the QSPI slave circuit 501 during a write access from the QSPI master device 410. FIG. 9B is a flowchart illustrating the processing performed by QSPI master circuit 502 during a write access from the QSPI master device 410.

In step S901, the QSPI slave circuit 501 determines whether the CS signal is asserted. In step S901, the QSPI slave circuit 501 determines whether the voltage level of the CS signal line 543 is low. At time T101, the QSPI master device 410 asserts the CS signal low. If the QSPI slave circuit 501 detects that the CS signal is asserted low (YES in step S901), the processing proceeds to step S902.

In step S902, the QSPI slave circuit 501 receives an opcode and stores the received opcode into a not-illustrated buffer. The buffer in which the opcode is stored is one different from the write buffer 511.

In step S903, the QSPI slave circuit 501 determines whether the reception of the opcode is completed. If two clocks' worth of data has been received after the assertion of the CS signal (YES in step S903), the processing proceeds to step S904. If the reception of two clocks' worth of data is not completed (NO in step S903), the processing returns to step S902, and the QSPI slave circuit 501 receives the opcode. At time T102, the QSPI slave circuit 501 completes receiving the opcode. At time T102, the QSPI slave circuit 501 analyzes the opcode and outputs the opcode 700.

In step S904, the QSPI slave circuit 501 receives an address and stores the received address into a not-illustrated buffer. The buffer in which the address is stored is one different from the buffer in which the opcode is stored and the write buffer 511. In step S905, the QSPI slave circuit 501 determines whether the reception of the address is completed. If six clocks' worth of data has been received after the completion of reception of the opcode, the QSPI slave circuit 501 determines that the reception of the address is completed (YES in step S905). The processing then proceeds to step S906. If the reception of six clocks' worth data is not completed (NO in step S905), the processing returns to step S904. At time T103, the QSPI slave circuit 501 completes receiving the address. The QSPI slave circuit 501 outputs the received address 701 to the signal lines 520 and 521.

In step S906, the QSPI slave circuit 501 asserts the data communication enable signal high. At time T104 after receiving eight clocks' worth of data since the CS signal is asserted to the low level, the QSPI slave circuit 501 sets the voltage level of the data communication enable 704 to a high level. The data communication enable signal is thereby asserted. The data communication enable signal is a signal indicating that the QSPI master circuits 502 and 503 can access the QSPI slave circuit 501.

In step S907, the QSPI slave circuit 501 receives write data from the QSPI master device 410. The QSPI slave circuit 501 receives the write data in synchronization with the clock signal from the SCK signal line 544, and writes the write data to a portion (location) of the write buffer 511 indicated by the write pointer 703 to the write buffer 511. In step S908, the QSPI slave circuit 501 increments the write pointer 703. If the write pointer 703 before the increment is 7, the QSPI slave circuit 501 sets the write pointer 703 to 0. The locations in the write buffer 511 indicated by the values 0 to 7 of the write pointer 703 will be referred to as write data buffers 0 to 7, respectively. The write data buffers 0 to 7 each store four bits' worth of data from the IO_0 to IO_3 signal lines 545 to 548.

In step S909, the QSPI slave circuit 501 determines whether the CS signal is negated. The QSPI slave circuit 501 determines whether the voltage level of the CS signal line 543 is high. If the voltage level of the CS signal line 543 is high, the QSPI slave circuit 501 determines that the CS signal is negated. If the CS signal is not negated (NO in step S909), the processing returns to step S907. In the present exemplary embodiment, the CS signal is negated at time T109. If the CS signal is negated (YES in step S909), the processing proceeds to step S910. In step S910, the QSPI slave circuit 501 sets the voltage level of the data communication enable 704 to a low level and thereby negates the data communication enable signal. At time T109, the QSPI slave circuit 501 sets the voltage level of the data communication enable 704 to the low level. This can stop accesses from the QSPI slave devices 412 and 413 to the QSPI master circuits 502 and 503.

Next, the processing performed by the QSPI master circuit 502 will be described with reference to FIG. 9B.

In step S911, the QSPI master circuit 502 determines whether the data communication enable signal is asserted. The QSPI master circuit 502 determines that the data communication enable signal is not asserted (NO in step S911), the processing returns to step S911. Unless the voltage level of the data communication enable 704 is changed to the high level via the signal line 520, the processing in step S911 is executed. If the voltage level of the data communication enable 704 becomes high at time T105 (YES in step S911), the processing then proceeds to step S912.

In step S912, the QSPI master circuit 502 obtains the address 701 input via the signal line 520, and determines whether the obtained address 701 designates the QSPI slave device 412 connected thereto. The QSPI master circuit 502 stores in advance the value of the 19th address bit of the QSPI slave device 412 connected thereto. In step S912, the QSPI master circuit 502 refers to the value of the 19th bit of the received address 701, and determines whether the write access is made to the QSPI slave device 412. If the slave device designated by the address 701 is not the QSPI slave device 412 connected to the QSPI master circuit 502 (NO in step S912), the processing illustrated in FIG. 9B is ended.

If the slave device designated by the address 701 is the QSPI slave device 412 connected to the QSPI master circuit 502 (YES in step S912), the processing proceeds to step S913. In step S913, the QSPI master circuit 502 asserts the CS signal. At time T105, the QSPI master circuit 502 sets the voltage level of the CS signal line 553 to the low level. With the voltage level of the CS signal line 553 set to the low level, the clock signal and data start to be supplied to the QSPI slave device 412.

In step S914, along with the assertion of the CS signal, the QSPI master circuit 502 cancels the gating of the clock signal by the SCK gate circuit 532. The QSPI master circuit 502 sets the voltage level of the CSK gate signal line 552 to the low level, whereby the gating of the clock signal is cancelled. The clock signal thus starts to be supplied to the QSPI slave device 412.

In step S915, the QSPI master circuit 502 outputs an opcode to the QSPI slave device 412 via the IO_0 to IO_3 signal lines 555 to 558. The QSPI master circuit 502 obtains the opcode 700 via the signal line 520, and outputs the opcode 700 via the four signal lines 555 to 558 in two clocks.

In step S916, the QSPI master circuit 502 outputs an address to the QSPI slave device 412 via the IO_0 to IO_3 signal lines 555 to 558. The QSPI master circuit 502 obtains the address 701 via the signal line 520 and outputs the address 701 to the QSPI slave device 412.

In step S917, the QSPI master circuit 502 obtains the value of the read pointer 705 in reading data from the write buffer 511. The QSPI master circuit 502 obtains the value of the read pointer 705 at time T106 after the assertion of the CS signal and the reception of the opcode and address. In step S918, the QSPI master circuit 502 reads write data from the write buffer 511 based on the value of the read pointer 705 obtained in step S917, and outputs the write data to the QSPI slave device 412 via the IO_0 to IO_3 signal lines 555 to 558.

In step S919, the QSPI master circuit 502 determines whether the write buffer 511 is empty. The QSPI master circuit 502 obtains the values of the write pointer 703 and the read pointer 705. If the obtained values of the write and read pointers 703 and 705 coincide, the QSPI master circuit 502 determines that the write buffer 511 is empty. If the write buffer 511 is not empty (NO in step S919), the processing proceeds to step S920. If the write buffer 511 is empty (YES in step S919), the processing proceeds to step S921. For example, at time T107, the write and read pointers 703 and 705 have different values, and the QSPI master circuit 502 determines that the write buffer 511 is not empty.

In step S920, the QSPI master circuit 502 increments the value of the read pointer 705 to the write buffer 511 by one. If the value of the read pointer 705 before the increment is 7, the QSPI master circuit 502 sets the value of the read pointer 705 to 0. The processing then returns to step S918.

If the write buffer 511 is determined to be empty in step S919, then in step S921, the QSPI master circuit 502 determines whether the data communication enable signal is negated. If the voltage level of the data communication enable 704 is low, the QSPI master circuit 502 determines that the data communication enable signal is negated.

In step S921, if the data communication enable signal is not negated (NO in step S921), the processing proceeds to step S922 since the QSPI master device 410 is still transferring data.

In step S922, the QSPI master circuit 502 controls the SCK gate circuit 532 to gate the clock signal supplied to the QSPI slave device 412. The data transfer to the QSPI slave device 412 is thereby suspended.

In step S923, the QSPI master circuit 502 determines again whether the write buffer 511 is empty. The QSPI master circuit 502 obtains the values of the write and read pointers 703 and 705, and compares the obtained values of the write and read pointers 703 and 705. If the values of the write and read pointers 703 and 705 coincide, the QSPI master circuit 502 determines that the write buffer 511 is empty. If the write and read pointers 703 and 705 have different values, the QSPI master circuit 502 determines that the write buffer 511 contains unread data and is not empty. For example, at time T108 of FIGS. 7A and 7B, both the read pointer 705 and the write pointer 703 have the same value. At time T108, the QSPI master circuit 502 determines that the write buffer 511 contains no unread data and is empty. In such a case, the QSPI master circuit 502 waits until data is accumulated in the write buffer 511, without supplying the clock signal to the QSPI slave device 412. After unread data is accumulated in the write buffer 511, the QSPI master circuit 502 resumes supplying the clock signal to the QSPI slave device 412 to resume writing data to the QSPI slave device 412.

If the write buffer 511 is empty (YES in step S923), the processing in step S923 is repeated. If there is no unread data in the write buffer 511, the supply of the clock signal to the QSPI slave device 412 is stopped until data to be read is accumulated in the write buffer 511.

If the write buffer 511 is not empty (NO in step S923), the processing proceeds to step S924. In step S924, the QSPI master circuit 502 controls the SCK gate circuit 532 to cancel the gating of the clock signal to the QSPI slave device 412 to resume supplying the clock signal. After the supply of the clock signal is resumed, the processing proceeds to step S920.

If, in step S921, the data communication enable signal is negated (YES in step S921), the processing proceeds to step S925. In step S925, the QSPI master circuit 502 sets the voltage level of the CS signal line 553 to the high level to negate the CS signal. If all the data stored in the write buffer 511 has been read and the QSPI master device 410 has completed transmitting the write data, the data transfer to the QSPI slave device 412 is completed. The QSPI master circuit 502 then negates the CS signal between the QSPI master circuit 502 and the QSPI slave device 412 to end the communication between the QSPI master circuit 502 and the QSPI slave device 412.

In the present exemplary embodiment, the clock signal supplied from the QSPI master circuit 502 to the QSPI slave device 412 has a frequency higher than that of the clock signal supplied from the QSPI master device 410 to the QSPI slave circuit 501. The reading speed of data from the write buffer 511 is thus higher than the writing speed to the write buffer 511. This can prevent the write buffer 511 from overflowing due to accumulation of data yet to be read therein. In the meantime, the writing to the write buffer 511 can fail to catch up and the write buffer 511 can be emptied. The supply of the clock signal to the QSPI slave device 412 is then stopped to suspend data transfer to the QSPI slave device 412. The data transfer to the QSPI slave device 412 is resumed after data is accumulated in the write buffer 511.

While the processing performed by the QSPI master circuit 502 has been described with reference to FIG. 9B, the processing illustrated in FIG. 9B is also performed by the QSPI master circuit 503. When the QSPI master circuit 503 performs the processing illustrated in FIG. 9B, the QSPI master circuit 503 determines in step S912 whether the received address designates the QSPI slave device 413.

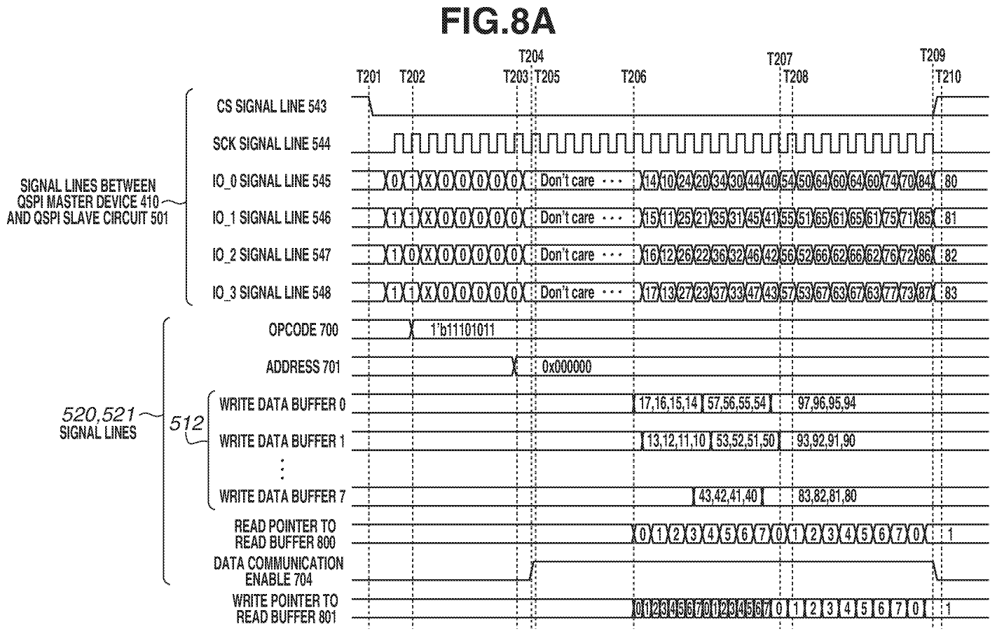

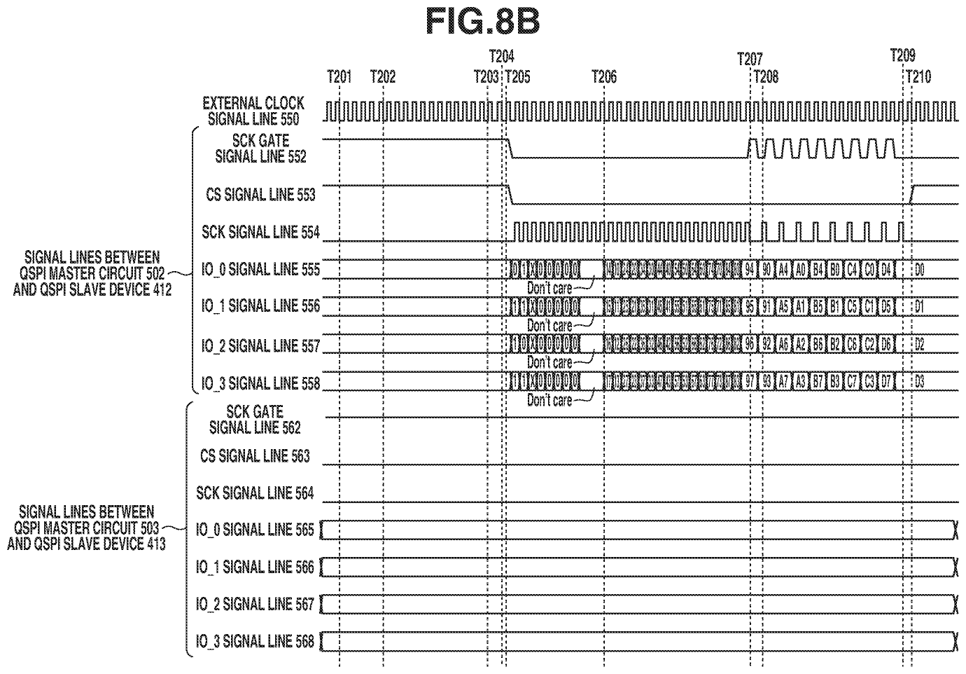

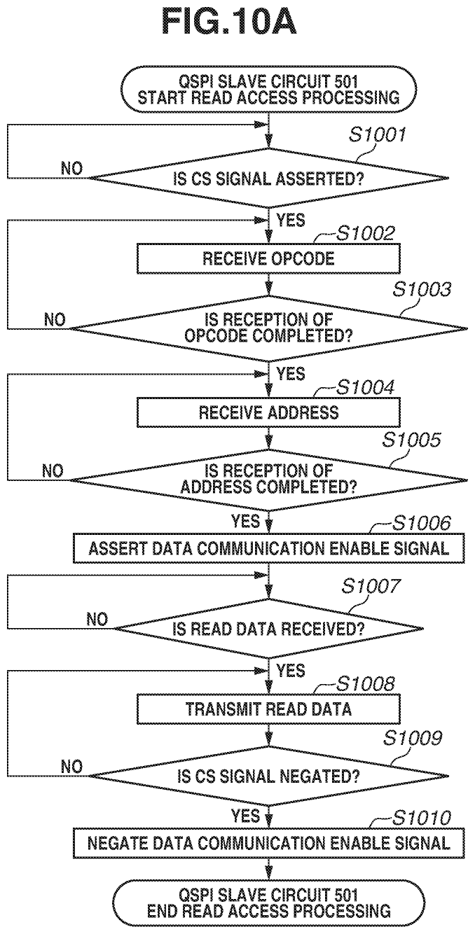

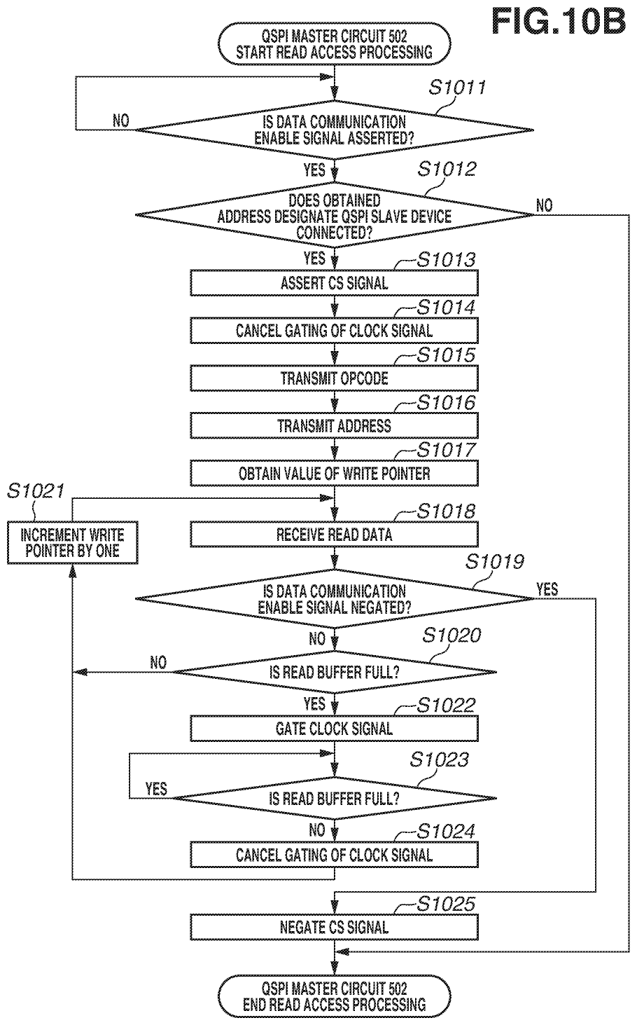

Next, the processing of the QSPI bridge device 411 during a read access will be described in detail with reference to FIGS. 8A, 8B, 10A, and 10B. FIGS. 8A and 8B are timing charts illustrating a processing flow executed when a read command is issued from the QSPI master device 410. In the present exemplary embodiment, the QSPI master device 410 reads data from the QSPI slave device 412.

In FIG. 8A, a read pointer 800 to a read buffer is a pointer indicating the access destination in the read buffer 512 or 513 in reading data stored in the read buffer 512 of the QSPI master circuit 502 or the read buffer 513 of the QSPI master circuit 503. A write pointer 801 to a read buffer is a pointer indicating the access destination in the read buffer 512 or 513 in storing data into the read buffer 512 of the QSPI master circuits 502 or the read buffer 513 of the QSPI master circuit 503.

FIG. 10A is a flowchart illustrating processing performed by the QSPI slave circuit 501 when a read command is issued by the QSPI master device 410.

In step S1001, the QSPI slave circuit 501 determines whether the CS signal is asserted. At time T201, to start a read operation on the QSPI bridge device 411, the QSPI master device 410 sets the voltage level of the CS signal line 543 to a low level. If the CS signal is asserted (YES in step S1001), the processing proceeds to step S1002.

In step S1002, the QSPI slave circuit 501 receives an opcode from the QSPI master device 410 via the IO_0 to IO_3 signal lines 545 to 548. The QSPI slave circuit 501 receives the opcode and stores the received opcode in the not-illustrated buffer. In step S1003, the QSPI slave circuit 501 determines whether the reception of the opcode is completed. If the reception of the opcode is completed (YES in step S1003), the processing proceeds to step S1004. If the reception of the opcode is not completed (NO in step S1003), the processing returns to step S1002, and the QSPI slave circuit 501 continues to receive the opcode. At time T202, the QSPI slave circuit 501 completes receiving the opcode from the QSPI master device 410. The QSPI slave circuit 501 stores the received opcode, and outputs the opcode 700 to the QSPI master circuits 502 and 503 via the signal lines 520 and 521.

In step S1004, the QSPI slave circuit 501 receives an address from the QSPI master device 410. The QSPI slave circuit 501 stores the received address 701 into the not-illustrated buffer, and outputs the address 701 to the QSPI master circuit 502 and 503 via the signal lines 520 and 521. In step S1005, the QSPI slave circuit 501 determines whether the reception of the address is completed. If the QSPI slave circuit 501 determines that the reception of the address is completed (YES in step S1005), the processing proceeds to step S1006. If the QSPI slave circuit 501 determines that the reception of the address is not completed (NO in step S1005), the processing returns to step S1004. At time T203, the QSPI slave circuit 501 completes receiving the address. The QSPI slave circuit 501 analyzes the received address, and determines whether the device designated by the address is the QSPI slave device 412 or the QSPI slave device 413. In the following description, when the QSPI slave circuit 501 reads data from a read buffer, the QSPI slave circuit 501 reads the data from the read buffer of the QSPI master circuit connected to the QSPI slave device determined in step S1005.

In step S1006, the QSPI slave circuit 501 asserts the data communication enable signal. At time T204, the QSPI slave circuit 501 sets the voltage level of the data communication enable 704 to the high level. In step S1007, the QSPI slave circuit 501 determines whether read data is received from the QSPI slave device 412 or 413 via the signal line 520 or 521. If no read data is received (NO in step S1007), the processing in step S1007 is repeated until the QSPI slave circuit 501 receives read data. In other words, the QSPI slave circuit 501 performs the processing of step S1007 during a dummy cycle. If read data is received (YES in step S1007), the processing proceeds to step S1008. In step S1008, the QSPI slave circuit 501 transmits the received read data to the QSPI master device 410 via the IO_0 to IO_3 signal lines 545 to 548.

In step S1009, the QSPI slave circuit 501 determines whether the CS signal output from the QSPI master device 410 is negated. If the QSPI slave circuit 501 determines that the CS signal output from the QSPI master device 410 is not negated (NO in step S1009), the processing returns to step S1008. If the voltage level of the CS signal line 543 is high, the QSPI slave circuit 501 determines that the CS signal is negated (YES in step S1009). The processing then proceeds to step S1010. In step S1010, the QSPI slave circuit 501 negates the data communication enable signal. At time T209, the QSPI master device 410 negates the CS signal. At time T210, the QSPI slave circuit 501 sets the voltage level of the data communication enable 704 to the low level.

FIG. 10B is a flowchart illustrating processing performed by the QSPI master circuit 502.

In step S1011, the QSPI master circuit 502 determines whether the data communication enable signal is asserted. In step S1011, if the voltage level of the data communication enable 704 is high, the QSPI master circuit 502 determines that the data communication enable signal is asserted. If the QSPI master circuit 502 determines that the data communication enable signal is not asserted (NO in step S1011), the QSPI master circuit 502 repeats the processing of step S1009 until the data communication enable 704 is asserted at time T205.

If the data communication enable signal is asserted (YES in step S1011), the processing proceeds to step S1012. In step S1012, the QSPI master circuit 502 determines whether the address 701 received via the signal line 520 designates the QSPI slave device 412 connected thereto. If the address 701 received via the signal line 520 designates the QSPI slave device 412 (YES in step S1012), the processing proceeds to step S1013. If the address 701 received via the signal line 520 does not designate the QSPI slave device 412 (NO in step S1012), the processing illustrated in FIG. 10B ends.

In step S1013, the QSPI master circuit 502 asserts the CS signal. At time T205, the QSPI master circuit 502 sets the voltage level of the CS signal line 553 to a low level, whereby the CS signal is asserted. In step S1014, the QSPI master circuit 502 sets the voltage level of the SCK gate signal line 552 to the low level, whereby the gating of the clock signal by the SCK gate circuit 532 is cancelled.

In step S1015, the QSPI master circuit 502 transmits the opcode to the QSPI slave device 412 via the IO_0 to IO_3 signals 555 to 558. In step S1016, the QSPI master circuit 502 transmits the address to the QSPI slave device 412 via the IO_0 to IO_3 signal lines 555 to 558. In step S1017, the QSPI master circuit 502 reads the value of the write pointer 801 in accessing the read buffer 512. At time T206, the QSPI master circuit 502 obtains the value of the write pointer 801 to the read buffer 512.

In step S1018, the QSPI master circuit 502 receives read data from the QSPI slave device 412, and stores the received read data into a location of the read buffer 512 designated by the value of the write pointer 801 read in step S1017. In the present exemplary embodiment, a dummy cycle when a read command is issued is three cycles, whereas the number of cycles is not limited thereto.

In step S1019, the QSPI master circuit 502 determines whether the data communication enable signal is negated. If the voltage level of the data communication enable 704 is determined to be low, the QSPI master circuit 502 determines that the data communication enable signal is negated. If the data communication enable signal is negated (YES in step S1019), the processing proceeds to step S1025.

If the data communication enable signal is not negated (NO in step S1019), the processing proceeds to step S1020. In step S1020, the QSPI master circuit 502 determines whether the read buffer 512 is full. The QSPI master circuit 502 compares the values of the write pointer 801 and the read pointer 800 in accessing the read buffer 512. If the values of the write pointer 801 and the read pointer 800 coincide, the QSPI master circuit 502 determines that the read buffer 512 is full. If the read buffer 512 is not full (NO in step S1020), the processing proceeds to step S1021. In step S1021, the QSPI master circuit 502 increments the value of the write pointer 801 by one.

If the read buffer 512 is full (YES in step S1020), the processing proceeds to step S1022. In step S1022, the QSPI master circuit 502 performs control to gate the clock signal so that the clock signal is not input to the QSPI slave device 412. For example, at time T207, the values of the write pointer 801 and the read pointer 800 to the read buffer 512 coincide. The QSPI master circuit 502 determines that the read buffer 512 is full, and sets the voltage level of the SCK gate signal line 552 to a high level. The clock signal is thereby controlled to not be input to the QSPI slave device 412.

In step S1023, the QSPI master circuit 502 determines whether the read buffer 512 is full. In step S1023, the QSPI master circuit 502 compares the values of the write pointer 801 and the read pointer 800 to the read buffer 512. If the values of the write pointer 801 and the read pointer 800 coincide, the QSPI master circuit 502 determines that the read buffer 512 is full.

If the read buffer 512 is not full (NO in step S1023), the processing proceeds to step S1024. In step S1024, the QSPI master circuit 502 sets the voltage level of the SCK gate signal line 552 to the low level, whereby the gating of the clock signal by the SCK gate circuit 532 is cancelled. The clock signal is thus supplied to the QSPI slave device 412 again. For example, if the read pointer 800 and the write pointer 801 have different values, the QSPI master circuit 502 determines that the read buffer 512 is not full. In other words, the read buffer 512 can store data read from the QSPI slave device 412. In such a case, the QSPI master circuit 502 cancels the gating of the clock signal to the QSPI slave device 412, and resumes reading the read data. In the present exemplary embodiment, only the clock signal is gated as described above without negating the CS signal input to the QSPI slave device 412. In such a manner, the data transfer can be suspended without terminating the communication between the QSPI bridge device 411 and the QSPI slave device 412. The data transfer can therefore be resumed by cancelling the gating of the clock signal without the QSPI bridge device 411 outputting a command or an address to the QSPI slave device 412.

If the data communication enable signal is negated in step S1019 (YES in step S1019), then in step S1025, the QSPI master circuit 502 sets the voltage level of the CS signal line 553 to a high level, whereby the CS signal is negated. The processing illustrated in FIGS. 10A and 10B is thereby ended.

In the present exemplary embodiment, the QSPI master circuits 502 and 503 are supplied with the clock signal having a frequency higher than that of the clock signal supplied to the QSPI slave circuit 501. When the QSPI master device 410 issues a read command, this makes reading from the read buffers 512 and 513 slower than writing to the read buffers 512 and 513. The read buffers 512 and 513 then can be filled with unread data. If the read buffers 512 and 513 are filled with unread data, the QSPI master circuits 502 and 503 therefore temporarily stop supplying the clock signals to the QSPI slave devices 412 and 413. The QSPI master circuits 502 and 503 temporarily stop reading data from the QSPI slave devices 412 and 413, and only a data read from the read buffers 512 and 513 by the QSPI slave circuit 501 is performed. This can prevent data loss due to overflow of the read buffers 512 and 513.

As described above, if the QSPI master device 410 and a QSPI slave device are connected by using the QSPI bridge device 411, a clock signal different from that supplied from the QSPI master device 410 is supplied to the QSPI slave device. The clock signal supplied to the QSPI slave device continues to be supplied at least while the QSPI bridge device 411 and the QSPI slave device transfer data therebetween. This enables the QSPI bridge device 411 to perform the data transfer with the QSPI slave device to the end.

The QSPI bridge device 411 supplies the QSPI slave device with a clock signal having a frequency higher than that of the clock signal supplied from the QSPI master device 410. Data transferred from the QSPI master device 410 to the QSPI bridge device 411 can thus be transferred to the QSPI slave device without the buffers in the QSPI bridge device 411 overflowing with the data.

### Other Exemplary Embodiments

In the present exemplary embodiment, the processing illustrated in FIGS. 9A, 9B, 10A, and 10B is described to be performed by using the QSPI slave circuit 501 and the QSPI master circuits 502 and 503. The CPU 1110 may perform the processing by controlling the QSPI bridge device 411.

The foregoing exemplary embodiment has been described by using the case where the data transfer speed between the QSPI master device 410 and the QSPI bridge device 411 is different from that between the QSPI bridge device 411 and the QSPI slave devices 412 and 413 as an example. In the foregoing exemplary embodiment, the write buffer 511 and the read buffers 512 and 513 can be emptied or run short of free data space due to the difference between the data transfer speeds. Even with the same data transfer speeds, the buffers 511, 512, and 513 can be emptied or filled up in the following cases. For example, suppose that the QSPI master device 410 stops outputting the clock signal to temporarily stop data input/output during a write access without negating the CS signal. Since the write access between the QSPI bridge device 411 and the QSPI slave devices 412 and 413 continues, the write buffer 511 can be emptied. That is, there is no more data to be written to the QSPI slave devices 412 and 413. In such a case, the data transfer from the QSPI bridge device 411 to the QSPI slave devices 412 and 413 is suspended. Suppose that the QSPI master device 410 stops outputting the clock signal to temporarily stop data input/output while making a read access to the QSPI bridge device 411, without negating the CS signal. Since the read access between the QSPI bridge device 411 and the QSPI slave devices 412 and 413 continues, the read buffers 512 and 513 can be full of read data and thus run short of free space. In such a case, the reading of data from the QSPI slave devices 412 and 413 can be suspended to prevent the occurrence of situations where read data is unable to be stored in the read buffer 512 or 513. As described above, even if the data transfer speed between the QSPI master device 410 and the QSPI bridge device 411 and that between the QSPI bridge device 411 and the QSPI slave devices 412 and 413 are the same, the buffers 511, 512, and 513 can be prevented from being emptied or running short of free data space by performing the control according to the present exemplary embodiment.

An exemplary embodiment of the present invention can be implemented by performing the following processing. The processing includes supplying software (program) for implementing the functions of the foregoing exemplary embodiment to a system or an apparatus via a network or various storage media, and reading and executing the program code (program) by a computer (or CPU or microprocessing unit (MPU)) of the system or apparatus. In such a case, the computer program and the storage medium storing the computer program constitute the present exemplary embodiment.

An exemplary embodiment of the present invention can prevent a buffer from running short of free space or running short of data to be read in performing data transfer between a master device and a slave device by using a bridge device including the buffer.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-163192, filed Aug. 31, 2018, which is hereby incorporated by reference herein in its entirety.

What is claimed is:

1. A bridge device comprising:
a first communication unit configured to perform data transfer with a first device based on a command received from the first device;
a second communication unit configured to perform data transfer with a second device based on the command received from the first device;
a storage unit configured to store data input via the first communication unit or the second communication unit; and
a control unit configured to stop the data transfer of the second communication unit with the second device based on a state of the storage unit.

2. The bridge device according to claim 1,
wherein the second communication unit is configured to store data read from the second device into the storage unit based on a command for reading data, the command being received from the first device,
wherein the first communication unit is configured to output the data stored in the storage unit to the first device based on the command for reading the data, the command being received from the first device, and
wherein the control unit is configured to stop reading of the data from the second device in a case where the storage unit is not able to store the data read from the second device.

3. The bridge device according to claim 2, wherein the control unit is configured to, if the data stored in the storage unit is only data yet to be output by the first communication unit, determine that the storage unit is not able to store the data read from the second device.

4. The bridge device according to claim 2, wherein the control unit is configured to, after the reading of the data from the second device is stopped, resume the reading of the data from the second device in a case where the first communication unit outputs the data stored in the stored in the storage unit to the first device.

5. The bridge device according to claim 2, wherein the control unit is configured to stop the reading of the data by the second communication unit in a case where a pointer indicating a location where to write the data read from the second device by the second communication unit and a pointer indicating a location where data to be read by the first communication unit from the storage unit is stored coincide in value.

6. The bridge device according to claim 1,
wherein the first communication unit is configured to store data input from the first device into the storage unit based on a command for writing the data input from the first device to the second device,
wherein the second communication unit is configured to output the data stored in the storage unit to the second device based on the command for writing the data input from the first device to the second device, and
wherein the control unit is configured to stop writing of the data to the second device by the second communication unit in a case where no data to be written to the second device by the second communication unit is stored in the storage unit.

7. The bridge device according to claim 6, wherein the control unit is configured to resume the writing of the data to the second device by the second communication unit in a case where data to be written to the second device by the second communication unit is stored in the storage unit.

8. The bridge device according to claim 6, wherein the control unit is configured to compare a value of a pointer indicating a location where to store data input via the first communication with a value of a pointer indicating a location where data to be output by the second communication unit is stored, and stop the writing of the data to the second device by the second communication unit.

9. The bridge device according to claim 1, wherein the first communication unit is configured to communicate with the first device based on a clock signal output from the first device.

10. The bridge device according to claim 1, wherein the first communication unit is configured to transfer a command for controlling the second device, an address, and data by using a same signal line.

11. The bridge device according to claim 1, wherein the first communication unit is configured to perform communication compliant with a Serial Peripheral Interface (SPI) standard with the first device.

12. The bridge device according to claim 1, wherein the second communication unit is configured to perform communication compliant with an SPI standard with the second device.

13. The bridge device according to claim 1,
wherein the second communication unit is configured to output, to the second device, a clock signal to be used for the data communication with the second device, and
wherein the control unit is configured to stop the data transfer with the second device by gating the clock signal output from the second communication unit.

14. The bridge device according to claim 1,
wherein the bridge device is configured to assert a chip select signal indicating that communication is performed with the second device, and
wherein the control unit is configured to stop the data transfer with the second device without negating the chip select signal asserted by the bridge device.

15. The bridge device according to claim 1, wherein the second communication unit is configured to, in a case where the data transfer with the second device is resumed by the control unit, resume the data transfer without outputting a command or address to the second device.

16. The bridge device according to claim 1, wherein the control unit is configured to stop the data transfer of the second communication unit with the second device without stopping communication of the first communication unit.

17. A method for controlling a bridge device, comprising:
performing data transfer with a first device as a first communication based on a command received from the first device;
performing data transfer with a second device as a second communication based on the command received from the first device;
storing data input by the first communication or the second communication into a storage unit; and
stopping the data transfer with the second device based on a state of the storage unit.

18. An information processing apparatus including a bridge device comprising:
a first communication unit configured to perform data transfer with a first device based on a command received from the first device;
a second communication unit configured to perform data transfer with a second device based on the command received from the first device;
a storage unit configured to store data input via the first communication unit or the second communication unit; and
a control unit configured to stop the data transfer of the second communication unit with the second device based on a state of the storage unit.
